(19) United States
(12) Patent Application Publication
(10) Pub. No.: US 2007/0105745 A1
(43) Pub. Date: May 10, 2007

(54) FABRIC SOFTENER WITH ODOR CONTROL

(75) Inventors: Jessica Lawshe, Chandler, AZ (US); Thorsten Bastigkeit, Scottsdale, AZ (US); Ronnie Casey, New River, AZ (US); Michael Mathiesen, Scottsdale, AZ (US); Joan Bergstrom, Phoenix, AZ (US)

Correspondence Address: SNELL & WILMER, LLP (Dial Corp), ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 11/556,877

(22) Filed: Nov. 6, 2006

Related U.S. Application Data
(60) Provisional application No. 60/597,050, filed on Nov. 7, 2005.

(51) Int. Cl. C11D 3/32

(52) U.S. Cl. 510/516

(57) ABSTRACT

A fabric softener for neutralizing malodors comprising from about 0.01% to about 5% by weight of zinc ricinoleate, about 1.0% to about 90% by weight of a cationic surfactant, and a pH of from about 2.0 to about 5.0.

### CROSS-REFERENCE TO RELATED APPLICATIONS

This application claims priority to the provisional patent application filed Nov. 7, 2005, with the U.S. Patent and Trademark Office entitled “Fabric Softener with Odor Control” and assigned Ser. No. 60/597,050.

### FIELD OF INVENTION

The present invention relates to fabric softeners that can neutralize odors on fabric while the fabric is being worn, as well as removing existing odors on such fabrics while being laundered.

### BACKGROUND

It is widely known that malodors (i.e., undesirable odors) can be controlled and in some instances eliminated by utilizing; a deodorizing method, a masking process, an absorption process, an ozone deodorizing process, or a catalytic process, which uses a catalytic material such as a metal oxide or enzyme.

Masking processes control malodors by vaporizing and dispersing an aromatic liquid or solid such as a perfume into the ambient containing the malodor. Thus, masking processes modify the malodor to a more pleasant character by superimposing a dominant, but more pleasant odorant into the ambient. One problem with conventional aromatic liquids and solids is that such compounds tend to evaporate over an extended period of time, which may result in the return of the malodor.

Absorption processes control malodors by employing an absorbent such as activated carbon or the like which absorbs odor components from the ambient. Thus, in this process, the level of intensity of the malodor is constantly being reduced from the ambient and thereby refreshing the ambient.

The ozone deodorizing process serves to decompose odor components with ozone and in catalytic processes the odor components are modified in some fashion by the catalyst being used. In typical catalytic processes, enzymes are employed as the deodorizers.

In many home care applications, malodor control and/or elimination is achieved mainly by using either a masking process or an absorption process since ozone and catalytic processes are generally not feasible.

Some commonly employed odor absorbents in home care applications are formulations that are based on bleach oxidizing agents, peroxides, bactericides which kill microorganisms, cyclodextrins, and/or zinc ricinoleate. Such compounds tend to form strong bonds with malodor molecules containing sulfur and nitrogen atoms.

That said, heretofore, such compositions were not without limitations. For example, in order for compositions such as zinc ricinoleate to form bonds with malodor molecules, the zinc atoms need to be activated so as to expose their action sites. The activation of zinc ricinoleate is typically achieved by solubilizing the compound in water, a non-trivial matter.

Accordingly, fabric softeners with malodor neutralizing agents are desirable.

### SUMMARY OF THE INVENTION

The present invention provides a liquid fabric softener capable of not only removing malodor from laundered items but also neutralizing the odor on fabric while the fabric is being used or worn. For example, a fabric softener in accordance with the present invention utilizes an active malodor neutralizing agent, such as a metallic salt (e.g., zinc ricinoleate), in an aqueous fabric softener product and is very effective in controlling malodor.

In one exemplary embodiment, zinc ricinoleate is the active malodor neutralizing agent. Pure zinc ricinoleate is a waxy solid that is substantially insoluble in water. Although it is difficult to solubilize the zinc ricinoleate in water, under the proper conditions, an aqueous fabric softener composition including zinc ricinoleate, a cationic surfactant and a pH neutralizing and stabilizing ingredient provides a liquid product which is not only good for softening fabrics, but is stable and effectively controls malodor.

For example, a fabric softener composition in accordance with an embodiment of the present invention comprises from about 0.01% to about 5% by weight of zinc ricinoleate, about 1.0% to about 90% by weight of a cationic surfactant, and a pH of from about 2.0 to about 5.0, is a very effective product.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims. Additionally, though described herein in terms of a liquid fabric softener, other cleansing and treating materials, such as bleaches, disinfectants, soaps, deodorants, liquid detergents, stain treaters, dryer sheets or the like, may likewise fall within the ambit of the present invention.

That said, the present invention relates to an aqueous fabric softener which is an effective conditioner and softener for fabric, is stable, and importantly, comprises an active malodor neutralizing agent, effective in controlling malodor, for use during the rinse cycle of washing and is effective at neutralizing odor on fabric when the fabric is used or worn.

As noted above, in accordance with various embodiments of the present invention, the liquid fabric softener comprises an active malodor neutralizing agent.

The active malodor neutralizing agent comprises any agent that is capable of reducing the level of undesirable malodors available for human perception or that is capable of otherwise decreasing the level to which malodors are perceived.

In this regard, a variety of mechanisms exist by which a malodor neutralizing agent may reduce perceptible malodors, such as, for example, chemically reacting with malodor molecules, complexing with malodor molecules, absorbing malodor molecules, encapsulating malodor molecules, and/or influencing the ability of human sensory receptors to perceive malodors (e.g., anosmia).

For example, active malodor neutralizing agents suitable for use in accordance with an exemplary embodiment of the invention may combat malodors by chemically reacting or complexing with malodor molecules, by blocking human sensory reception sites that detect the presence of malodor, or by otherwise treating, blending, reacting, or counteracting malodors, without increasing the perceived overall odor level in a particular environment.

In accordance with one aspect of an exemplary embodiment of the invention, metallic salts can be used effectively as active malodor neutralizing agents. For example, an active malodor neutralizing agent may comprise a metallic salt, preferably a water-soluble zinc salt. Preferably, the metallic salt is at least one of zinc ricinoleate, zinc chloride, zinc gluconate, zinc lactate, zinc maleate, zinc salicylate, zinc sulfate, and mixtures thereof. Most preferably, the metallic salt is zinc ricinoleate.

Zinc ricinoleate controls malodors selectively through a chemical binding of low molecular weight organic compounds containing the osmogene functional groups. On the other hand, zinc ricinoleate generally has no effect on carbonylic groups, such as aldehydes and ketones, which comprise typical perfume and fragrance components.

Beneficially, zinc ricinoleate may stably complex with malodor molecules. The mode by which zinc ricinoleate complexes with malodors is similar to and can be compared to the iron binding and transport of oxygen in hemoglobin—the zinc acts as a catalyst to bind the malodor molecules, complexing it with the fatty acid side chains of the zinc ricinoleate molecule. In this way, the zinc ricinoleate neutralizes the malodors—that is, it reduces the level of undesirable malodors available for human perception.

Preferably, in accordance with the present invention, zinc ricinoleate molecules complex with one or more malodor molecules, depending on the size and shape of the malodor molecule(s). Once the complex is formed, it is a stable complex, that is, the malodor molecule will not be released from the zinc ricinoleate, even when the substrate dries.

Referring now to an exemplary embodiment of a liquid fabric softener noted above, the malodor neutralizing agent is zinc ricinoleate, for example such as that commercially available under the trade name TegoSorb from Degussa Goldschmidt Chemical Corporation in Hopewell, Va., USA. In this embodiment, the zinc ricinoleate is an active agent used at a level of about 0.01% to about 5.0% by weight, preferably at a level of about 0.2% to about 1.0% and most preferably about 0.5% by weight.

As mentioned above, the activation of zinc ricinoleate is typically carried out by solubilizing the compound. Once in solution the reaction sites on the zinc atoms are available to form bonds with nitrogen and sulfur atoms thereby bonding with the malodor. However, pure zinc ricinoleate, is a waxy solid and substantially insoluble. Therefore, the incorporation of the zinc ricinoleate into an aqueous product presents considerable difficulties. In fact, experiments have shown that when the zinc ricinoleate was combined with an aqueous surfactant (fabric softener), the zinc ricinoleate would precipitate out of the formula.

In accordance with various embodiments of the present invention, the laundry fabric softener comprises a cationic surfactant. In this regard, a variety of cationic surfactants may be utilized. For example, useful cationic synthetic surfactants include linear alkyl, branched alkyl, hydroxyalkyl, oleyl alkyl, acyloxyalkyl, diamidoamine, imidazoline or diester quaternary ammonium compounds, silicone, and aminosilicone compounds. The cationic surfactant in accordance with a preferred embodiment is at a level from about 1.0% to about 90.0% by weight of the fabric softener, preferably about 2% to about 25% and most preferably at a level of about 3% to about 15%.

Furthermore, in some embodiments, additional ingredients such as perfumes and dyes, and acids to prevent yellow discoloration of fabrics. A control pH may also be added without deviating from the scope of the present invention.

To control the pH of the composition according to the invention into the desired range, the use of pH standardizers and/or stabilizer may be used.

In accordance with an important aspect of the present invention, in order to provide a stable aqueous laundry fabric softener, the pH should be adjusted and maintained in a range of between about 2.0 to about 5.0, preferably from about 2.0 to about 4.0 and most preferably to a pH of about 2.5. In a preferred embodiment, citric acid is used to lower the pH to the desired level. However, other acids such as phosphoric acid, sulfuric acid, stearic acid and the like, or any other method of pH control known or as yet unknown in the art may be used to lower the pH.

Adjusting the pH is important. Thus, it is important to not only lower the pH but to stabilize the pH in the above noted ranges so that the ultimate product is stable and no precipitation of the zinc ricinoleate takes place for a lengthy period. Useful pH stabilizers include all known acids and alkalis unless their use is ruled out by performance or ecological concerns or by consumer protection concerns. Typically, the amount of these stabilizers does not exceed about 1% by weight of the total formulation.

In accordance with an aspect of the present invention, the composition may comprise UV absorbers. The compositions that comprise UV absorbers go onto the treated textiles and improve the light stability of the fibers and/or the light stability of the other formula components. UV absorbers should be understood to mean organic substances (light filters) that are capable of absorbing ultraviolet rays and reemitting the absorbed energy in the form of longer-wave radiation, e.g. heat. Examples of compounds that have these desired properties are the compounds, active through non-radiative deactivation, and derivatives of benzophenone with substituents in the 2-and/or 4-position. Further, substituted benzotriazoles, such as for example the water-soluble benzenesuIfonic acid-3-(2H-benzotriazol-2-yl )-4-hydroxy-5-(methylpropyl)-monosodium salt (Cibafast® H), acrylates phenyl-substituted in the 3-position (cinnamic acid derivatives), optionally with cyano groups in the 2-position, salicylates, organic Ni complexes and natural substances such as umbelliferone and the endogenous urocanic acid are suitable. Of particular importance are biphenyl derivatives and, above all, stilbene derivatives, which are commercially available from Ciba as Tinosorb® FD or Tinosorb® FR. As UV-B absorbers, mention can be made of 3-benzylidenecamphor and 3-benzylidene-norcamphor and derivatives thereof, e.g. 3-(4-methylbenzylidene)camphor, 4-aminobenzoic acid derivatives, preferably 4-(dimethylamino)benzoic acid 2-ethylhexyl ester, 4-(dimethylamino)benzoic acid 2-octyl ester, and 4-(dimethylamino)benzoic acid amyl ester; esters of cinnamic acid, preferably 4-methoxycinnamic acid 2-ethylhexyl ester, 4-methoxycinnamic acid propyl ester, 4-methoxycinnamic acid isoamyl ester, and 2-cyano-3,3-phenylcinnamic acid 2-ethylhexyl ester (Octocrylene); esters of salicylic acid, preferably salicylic acid 2-ethylhexyl ester, salicylic acid 4-isopropylbenzyl ester, and salicylic acid homomenthyl ester; derivatives of benzophenone, preferably 2-hydroxy-4-methoxybenzophenone, 2-hydroxy-4-methoxy-4′-methylbenzophenone, and 2,2′-dihydroxy-4-methoxy-benzophenone; esters of benzalmalonic acid, preferably 4-methoxybenzmalonic acid di-2-ethylhexyl ester; triazine derivatives such as for example 2,4,6-trianilino-(p-carbo-2′-ethyl-1′-hexyloxy)-1,3,5-triazine, octyl triazone, or dioctyl butamido triazone (Uvasorb® HEB); propane-1,3-diones such as for example 1-(4-tert-butylphenyl)-3-(4′-meth-oxyphenyl) propane-1,3-dione and ketotricyclo-(5.2.1.0)decane derivatives. Also suitable are 2-phenylbenzimidazole-5-sulfonic acid and alkali metal, alkaline earth metal, ammonium, alkylammonium, alkanolammonium and glucammonium salts thereof, sulfonic acid derivatives of benzophenones, preferably 2-hydroxy-4-methoxybenzophenone-5-sulfonic acid and salts thereof, sulfonic acid derivatives of 3-benzylidenecamphor, such as for example 4-(2-oxo-3-bornylidenemethyl) benzene-sulfonic acid and 2-methyl-5-(2-oxo-3-bornylidene)-sulfonic acid and salts thereof.

UV absorbers, if used, are typically used in amounts ranging up to about 1% by weight.

The compositions of the present invention may comprise crease control agents.

Since textile fabrics, especially those composed of rayon, wool, cotton and blends thereof, can tend to crease because the individual fibers are sensitive to bending, kinking, pressing and squashing transversely to the fiber direction, the compositions may comprise synthetic anticrease agents. These include for example synthetic products based on fatty acids, fatty acid esters, fatty acid amides, fatty acid alkylolesters, fatty acid alkylolamides or fatty alcohols, which have mostly been reacted with ethylene oxide, or products based on lecithin or modified phosphoric esters.

Crease control agents, if used, are typically used in amounts ranging up to about 1% by weight.

The compositions of the present invention may comprise grayness inhibitors.

Grayness inhibitors are designed to keep the soil detached from the fiber suspended in the liquor and to prevent its redeposition on the fiber. Useful grayness inhibitors include water-soluble colloids mostly organic in nature, for example glue, gelatin, salts of ether sulfonic acids of starch or of cellulose, or salts of acidic sulfuric esters of cellulose or of starch. Similarly, water-soluble polyamides which comprise acidic groups are suitable for this purpose. It is also possible to use soluble starch preparations and starch products other than those mentioned above, for example degraded starch, aldehyde starches, etc. Polyvinylpyrrolidone can be used as well. However, preference is given to cellulose ethers such as carboxymethylcellulose (sodium salt), methylcellulose, hydroxyalkylcellulose and mixed ethers such as methylhydroxyethylcellulose, methylhydroxypropylcellulose, and methyl-carboxymethylcellulose.

Grayness Inhibitors, if used, such inhibitors may be used in amounts ranging up to about 1% by weight.

In one aspect of an exemplary embodiment of the invention, an optical brightener (so-called “whitening agents”) component may be present in an amount from about 0.5 to about 3.0% by weight, based on the finished product. The optical brightener agent can comprise virtually any brightener that is capable of eliminating graying and yellowing of fabrics. Typically, these substances attach to the fibers and bring about a brightening and simulated bleaching action by converting invisible ultraviolet radiation into visible longer-wave length light. The ultraviolet light absorbed from sunlight irradiate as a pale bluish fluorescence and, together with the yellow shade of the grayed or yellowed laundry, produces pure white.

In one embodiment, the preferred optical brightener is Tinopal UNPA, which is commercially available through the Ciba Geigy Corporation located in Switzerland.

Additional optical brighteners useful in accordance with a preferred embodiment of the present invention include, but are not limited to, the classes of substance of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazol, benzisoxazol and benzimidazol systems, and pyrene derivatives substituted by heterocycles, and the like.

In accordance with another aspect of an exemplary embodiment of the invention, coloring agents and dyes, especially bluing agents, may be added to increase aesthetic appeal and consumer performance impression of the composition. When present, such coloring agents and/or dyes are preferably used at very low levels such as from about 0.001 to 0.01% by weight of the composition, to avoid staining or marking surfaces on which the compositions may be used, such as fabrics.

In accordance with a preferred aspect of an exemplary embodiment of the invention, the composition comprises Liquitint Blue HP, available from Milliken Chemical Company.

However, a wide variety of coloring agents and dyes suitable for use in accordance with the present invention are well known to those skilled in the art. Other non-limiting examples of suitable dyes are, Liquitint Blue HP.RTM., Liquitint Blue 65. RTM., Liquitint Patent Blue.RTM., Liquitint Royal Blue.RTM., Liquitint Experimental Yellow 8949-43. RTM., Liquitint Green HMC.RTM., Liquitint Yellow II.RTM., and mixtures thereof, preferably Liquitint Blue HP.RTM., Liquitint Blue 65. RTM., Liquitint Patent Blue.RTM., Liquitint Royal Blue.RTM., Liquitint Experimental Yellow 8949-43. RTM., and mixtures thereof.

The compositions of the present invention may comprise builders.

Some of the builders customarily used in washing and cleaning compositions can be incorporated in the compositions of the present invention, including, for example, organic cobuilders.

Organic builder substances useful include, for example, the polycarboxylic acids that can be used in the form of their sodium salts, polycarboxylic acids referring to carboxylic acids having more than one acid function. Examples thereof are citric acid, adipic acid, succinic acid, glutaric acid, malic acid, tartaric acid, maleic acid, fumaric acid, sugar acids, amino carboxylic acids, nitrilotriacetic acid (NTA), derivatives thereof, and also mixtures of these. Preferred salts are the salts of polycarboxylic acids such as citric acid, adipic acid, succinic acid, glutaric acid, tartaric acid, sugar acids and mixtures of these.

The compositions of the present invention may, if appropriate, comprise builders in amounts of from 0.001% to 1.0% by weight.

The present invention's fabric softener compositions may also comprise suitable chelating agents. Chelating agents may include any agents used to deactivate hard water minerals such as calcium and magnesium and to reduce the effects of other dissolved metals such as manganese.

In a preferred embodiment of the present invention, the chelating agents are present in an amount from about 0.001% to about 0.01%.

In one embodiment, ethylenediaminetetraacetic acid (EDTA) is used as the chelating agent. Other preferred chelants according to the present invention can be selected from the group consisting of amino carboxylates, amino phosphonates, polyfunctionally-substituted aromatic chelating agents and mixtures thereof, all as hereinafter defined and all preferably in their acidic form. Amino carboxylates useful as chelating agents herein include ethylenediaminetetraacetic acid (EDTA), N-hydroxyethylethylenediaminetriacetates, nitrilotriacetates (NTA), ethylenediam ine tetraproprionates, ethylenediamine-N, N′-diglutamates, 2-hydroxypropylenediamine-N, N′-disuccinates, triethylenetetraaminehexacetates, diethylenetriaminepentacetates (DTPA) and ethanoldiglycines, including their water-soluble salts such as the alkali metal, ammonium, and substituted ammonium salts thereof and mixtures thereof.

Optionally, a solubilized preservative may be added to the composition of the present invention. Preferred levels of the preservative, when present, are up to about 1.0%.

It is preferable to utilize a preservative that is effective to inhibit and/or control both bacteria and fungi. In accordance with an aspect of an exemplary embodiment of the present invention, an effective amount of Dantogard® preservative, available from Lonza Group of Switzerland, is utilized. Additional suitable preservatives may include any organic preservative that will not adversely affect or damage fabric articles. Preferred water-soluble preservatives include, for example, glutaraldehyde halogenated compounds, hydantoin compounds, organic sulfur compounds, low molecular weight aldehydes, benzalkonium chlorides, alkylarylsulfonates, halophenols, cyclic organic nitrogen compounds, quaternary compounds, dehydroacetic acid, phenyl and phenoxy compounds.

A redeposition inhibitor (“grayness inhibitor”) may also be added to the composition of the present invention. Typically, the amount of these redeposition inhibitors does not exceed about 0.5% by weight of the total formulation. Redeposition inhibitors are any agent designed to keep the soil detached from the fiber suspended in the liquor and to prevent its redeposition on the fiber.

Useful redeposition inhibitors may include water-soluble colloids mostly organic in nature, for example glue, gelatin, salts of ether sulfonic acids of starch or of cellulose, or salts of acidic sulfuric esters of cellulose or of starch. Similarly, water-soluble polyamides which comprise acidic groups are suitable for this purpose. It is also possible to use soluble starch preparations and starch products other than those mentioned above, for example degraded starch, aldehyde starches, etc. Polyvinylpyrrolidone can be used as well. However, preference is given to cellulose ethers such as carboxymethylcellulose (sodium salt), methylcellulose, hydroxyalkylcellulose and mixed ethers such as methylhydroxy-ethylcellulose, methylhydroxypropylcellulose, and methylcarboxymethylcellulose.

Suitable anti-redeposition agents, which are also referred to as soil repellants, also include, for example, nonionic cellulose ethers, such as methylcellulose and methylhydroxypropylcellulose.

Optionally, dye transfer inhibitors may also be added to the present invention. Dye transfer inhibitors include any agent that is capable of preventing redeposition of free dyes onto textile. As a result, textiles keep their original color and whites stay white, even after multiple washes. Preferred levels of dye transfer inhibitors, when present, are up to about 0.5% by weight of the composition.

Useful dye transfer inhibitors include not only the polyvinylpyrrolidones of molecular weights in the range from about 15,000 to about 50,000, but also the polyvinylpyrrolidones having molar weights above about 1,000,000, especially from about 1,500,000 to about 4,000,000. They may also include the N-vinylimidazole-N-vinylpyrrolidone copolymers, the polyvinyloxazolidones, the copolymers based on vinyl monomers and carboxamides, the polyesters and polyamides containing pyrrolidone groups, the grafted polyamidoamines and polyethyleneimines, the polymers with amide groups from secondary amines, the polyamine N-oxide polymers, the polyvinyl alcohols, and the copolymers based on acrylamidoalkenylsulfonic acids. However, it is also possible to use enzymatic systems, comprising a peroxidase and hydrogen peroxide or a substance which in water provides hydrogen peroxide. The addition of a mediator compound for the peroxidase, for example, an acetosyringone, a phenol derivative, or a phenothiazine or phenoxazine, is preferred in this case, it being also possible to use abovementioned active polymeric dye transfer inhibitor substances as well. Polyvinylpyrrolidone for use in compositions of the invention preferably has an average molar mass in the range from 10,000 to 60,000, in particular in the range from 25,000 to 50,000. Among the copolymers, preference is given to those of vinylpyrrolidone and vinylimidazole in a molar ratio of 5:1 to 1:1 having an average molar mass in the range from 5,000 to 50,000, in particular from 10,000 to 20,000.

Furthermore, the present invention's liquid laundry fabric softener compositions may further comprise thickeners preferably in amounts up to about 10% by weight, more preferably up to 5% by weight and especially in the range from about 0.1 to about 1.0% by weight, each based on the entire composition.

The use of thickeners in the liquid laundry fabric softener compositions of the present invention will be particularly advantageous. The use of thickeners in particular in gel-like liquid laundry fabric softener compositions will boost consumer acceptance. The thickened consistency of the composition simplifies the application of the compositions directly to the stains to be treated. The kind of run-off familiar from thin liquid compositions is prevented as a result. In a preferred embodiment, the thickener comprises Acusol 430, available from Axo Chemical, Inc. Other suitable polymers include, but are not limited to, polymers originating in nature such as, agar-agar, carrageen, tragacanth, gum arabic, alginates, pectins, polyoses, guar flour, carob seed flour, starch, dextrins, gelatins and casein.

Modified natural substances originate primarily from the group of modified starches and celluloses, examples which may be mentioned here being carboxymethylcellulose and cellulose ethers, hydroxyethylcellulose and hydroxypropylcellulose, and carob flour ether.

A large group of thickeners which is used widely in very diverse fields of application are the completely synthetic polymers, such as polyacrylic and poly-methacrylic compounds, vinyl polymers, polycarboxylic acids, polyethers, polyimines, polyamides and polyurethanes.

Thickeners from said classes of substance are commercially widely available and are offered, for example, under the trade names Acusol®-820 (methacrylic acid (stearyl alcohol-20-EO) ester-acrylic acid copolymer, 30% strength in water, Rohm & Haas), Polygel®, such as Polygel DA (3V Sigma), Carbopol® (B.F. Goodrich), such as Carbopol 940 (molecular weight approximately 4.000.000), Carbopol 941 (molecular weight approximately. 1.250.000), Carbopol 934 (molecular weight approximately 3.000.000), Carbopol ETD 2623, Carbopol 1382 (INCI Acrylates/C10-30 Alkyl Acrylate Crosspolymer) and Carbopol Aqua 30, Aculyn® and Acusol® (Rohm & Haas), Tego® Degussa-Goldschmidt), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on β-D-glucose, D-manose, D-glucuronic acid, Schöner GmbH), Deuteron®-XN (nonionogenic polysaccharide, Schöner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A preferred polymeric polysaccharide thickener is xanthan, a microbial anionic heteropolysaccharide produced by Xanthomonas campestris and other species under aerobic conditions and has a molar mass in the range from 2 to 15 million g/mol. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan.

For example, in this respect, in accordance with various exemplary embodiments of the invention, a fragrance component in the fabric softener may comprise a malodor neutralizing agent insofar as it reduces the level of malodors available for human perception or otherwise decreases the level to which malodors are perceived. For example, fragrance components may perform a malodor neutralizing function as well as an odor masking function insofar as such fragrance components may react with malodor molecules to render them unperceivable by the human senses.

In an exemplary embodiment of the invention, a fragrance component may be present in an amount of from about 0.1 to about 2.0% by weight. For example, the fragrance component may comprise the synthetic products of the ester, ether, aldehyde, ketone, alcohol and hydrocarbon types. Preference, however, is given to using mixtures of different odorants, which together produce an appealing fragrance note. Such perfume oils may also contain natural odorant mixtures, as are obtainable from plant sources.

Fragrance components useful in the present invention are known in the art and are available from any number of sources. For example, in accordance with an exemplary embodiment of the invention, the composition comprises a Mountain Breeze scent, which is commercially available from the Lebermuth Company located in South Bend, Ind. However, it will be appreciated that any known or hereafter devised scent, such as for example, baby powder or lemon may be used in accordance with the present invention.

Similarly, in accordance with an aspect of another exemplary embodiment of the invention, cyclodextrin can be used effectively as a malodor neutralizing agent. Various types of cyclodextrins may be used in accordance with this aspect, including, for example, alpha-cyclodextrin, beta-cyclodextrin, gamma-cyclodextrin and/or their derivatives and/or mixtures thereof. That said, as those skilled in the art may come to appreciate, other compositions, metallic salts and the like, which exhibit the properties discussed herein, fall within the ambit of the present invention.

Thus, an aqueous fabric softener in accordance with the present invention helps to neutralize odors that can develop on fabric such as perspiration and smoke. An additional and very important benefit is not only does the laundry product neutralize malodors, it seems to neutralize only malodors and does not adversely effect fragrances that may be formulated into the laundry product.

The following is an example of the formulation of a liquid fabric softener made in accordance with the teachings of this invention.

| Ingredient | As Is % | As Is % | As Is % | As Is % |
|---|---|---|---|---|
| Water | QS | QS | QS | QS |
| TegoSorb Conc. 50 - | 0.20 | 0.20 | 0.20 | 0.20 |
| (Zn Ricinoleate) | | | | |
| TEA Esterquat | 3.50 | 11.20 | 0.00 | 0.00 |
| Diamidoamine Quaternary | 0.00 | 0.00 | 3.15 | 11.20 |
| Ammonium Compound | | | | |
| Calcium Chloride | 0.00 | 0.03 | 0.00 | 0.14 |
| Citric Acid | 0.00 | 0.00 | 0.05 | 0.40 |
| Polymer | 0.00 | 0.00 | 0.06 | 0.00 |
| Glutaraldehyde | 0.05 | 0.05 | 0.05 | 0.05 |
| Perfume | 0.17 | 0.51 | 0.19 | 0.76 |
| Dye | 0.01 | 0.01 | 0.01 | 0.01 |

Finally, while the present invention has been described above with reference to various exemplary embodiments, many changes, combinations and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other types of devices. These and other changes or modifications are intended to be included within the scope of the present invention.

What is claimed is:

1. A fabric softening composition for neutralizing malodors by absorption comprising:
a fabric softener;
a cationic surfactant from about 1% to about 90% by weight of the composition;
a metallic salt comprising zinc ricinoleate from about 0.01% to about 5% by weight
of the composition; and
the composition having a pH level from about 2.0 to about 5.

2. The composition according to claim 1 wherein said cationic surfactant comprises at least one from the following, linear alkyl, branched alkyl, hydroxyalkyl, oleyl alkyl, acyloxyalkyl, diamidoamine, imidazoline or diester quaternary ammonium compounds, silicone, and aminosilicone compounds.

3. The composition according to claim 2 wherein said catonic surfactants comprise an amount from about 2% to about 25% by weight of the composition.

4. The composition according to claim 2 wherein said catonic surfactants comprise an amount from about 4% to about 15% by weight of the composition.

5. The composition according to claim 1 wherein said metallic salt further comprises at least one from the following, zinc chloride, zinc gluconate, zinc lactate, zinc maleate, zinc salicylate, and zinc sulfate.

6. The composition according to claim 5 wherein said metallic salt comprises an amount from about 0.01% to about 5.0% by weight of the composition.

7. The composition according to claim 5 wherein said metallic salt comprises an amount from about 0.02% to about 1.0% by weight of the composition.

8. The composition according to claim 5 wherein said metallic salt comprises about 0.5% by weight of the composition.

9. The composition according to claim 5 wherein said metallic salt molecules complex with one or more malodor molecules.

10. The composition according to claim 1 wherein the composition further comprises an agent to adjust the pH level of the composition.

11. The composition according to claim 10 wherein said agent comprises at least one from the following, citric acid, phosphoric acid, sulfuric acid, and stearic acid.

12. The composition according to claim 1 wherein the composition comprises a pH level from about 2.0 to about 5.0.

13. The composition according to claim 1 wherein the composition comprises a pH level from about 3.0 to about 4.0.

14. The composition according to claim 1 wherein the composition comprises a pH level of about 2.5.

15. The composition according to claim 1 wherein the composition further comprises a fragrance.

16. The composition according to claim 1 wherein the composition further comprises a malodor neutralizing agent.

17. The composition according to claim 16 wherein the malodor neutralizing agent comprises a cyclodextrin.

18. The composition according to claim 17 wherein said cyclodextrin comprises at least one from the following, alpha-cyclodextrin, beta-cyclodextrin, and gamma-cyclodextrin.
